(19) United States
(12) Patent Application Publication
(10) Pub. No.: US 2003/0073337 A1
(43) Pub. Date: Apr. 17, 2003

(54) Cable end connector

(76) Inventor: Yang-Chu Guo, Kunsan (CN)

Correspondence Address: Wei Te (Joseph) Chung, Foxconn International, Inc., 1650 Memorex Drive, Santa Clara, CA, 95050, US

(21) Appl. No.: 10/039,688

(22) Filed: Oct. 29, 2001

(30) Foreign Application Priority Data
Oct. 12, 2001 (TW) 90217377

(51) Int. Cl. H01R 13/627

(52) U.S. Cl. 439/362

(57) ABSTRACT

A cable end connector includes a casing inside which a connector body is retained. Two fasteners are mounted in the casing on opposite sides of the connector body.. Each fastener includes an elongate rod having opposite ends on which a knob and a threading are respectively formed. A C-ring is mounted on the rod for supporting a helical spring that biases the rod in a predetermined direction. The helical spring has a number of regular turns having an outside diameter and an additional turn having an inside diameter corresponding to the outside diameter of the regular turns. The additional turns surrounds the last one of the regular turns, forming a continuous end turn having no unsecured free end of the wire that makes the spring. The continuous end turn is arranged against the C-ring and the continuity thereof ensures and effectively maintains the abutting engagement between the helical spring and the C-ring.

### FIELD OF THE INVENTION

The present invention generally relates to a cable end connector, and in particular to a fastener of a cable end connector.

### BACKGROUND OF THE INVENTION

Cable end connectors are commonly used to connect a cable to an electronic device for establishing electrical connection of the electronic device with a separate device. An example of the cable end connectors is shown in Taiwan Patent Application No. 87221630. FIG. 1 of the attached drawings illustrates such a conventional cable end connector which comprises a casing 2′ defining an interior space for accommodating a connector body (not shown in FIG. 1 for simplicity). A pair of fasteners 3′ (only one being shown in FIG. 1) is mounted in the casing 2′ on opposite sides of the connector body. Each fastener 3′ comprises an elongate rod 31′ rotatably supported in the casing 2′, having opposite ends with threading and a knob formed thereon respectively. A grounding ring 33′ is fit over and physically engages the rod 31′. A C-ring 32′ is fit in a circumferential groove (not labeled) defined in the rod 31′ for supporting a helical spring 34′. The helical spring 34′ biases the rod 31′ in a predetermined direction.

In the conventional design discussed above, the helical spring 34′ has an end that abuts against the C-ring 32′. A free end 321′ of a wire that makes the spring 34′ is free of support by the wire or the spring itself. The C-ring 32′ has a side opening 347′ for mounting the C-ring 32′ to the rod 31′. When the rod 31′ is rotated to threadingly engage the threaded end thereof with the corresponding threaded hole of the electronic device, the free end of the helical spring 34′ that abuts the C-ring 32′ may undesirably slide into the opening 347′ of the C-ring 32′, losing the abutting engagement with the C-ring 32′. Under such a condition, the helical spring 34′ can no longer bias the rod 31′.

It is thus desirable to provide a fastener of a cable end connector which overcomes the above discussed problem.

### SUMMARY OF THE INVENTION

Accordingly, an object of the present invention is to provide a cable end connector comprising a reliable fastener.

Another object of the present invention is to provide a fastener of a cable end connector which can effectively and reliably operate.

To achieve the above objects, in accordance with the present invention, there is provided a cable end connector comprising a casing inside which a connector body is retained. Two fasteners are mounted in the casing on opposite sides of the connector body. Each fastener includes an elongate rod having opposite ends on which a knob and a threading are respectively formed. A C-ring is mounted on the rod for supporting a helical spring that biases the rod in a predetermined direction. The helical spring has a number of regular turns having an outside diameter and an additional turn having an inside diameter corresponding to the outside diameter of the regular turns. The additional turns surrounds the last one of the regular turns, forming a continuous end turn having no unsecured free end of the wire that makes the spring. The continuous end turn is arranged against the C-ring and the continuity thereof ensures and effectively maintains the abutting engagement between the helical spring and the C-ring.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view showing a conventional cable end connector with a connector body and an upper portion of a casing removed for showing inside structure;

FIG. 2 is a perspective view showing a cable end connection assembly in accordance with the present invention;

FIG. 3 is an exploded view of a fastening device of the cable connection assembly of the present invention;

FIG. 4A is a side view of a spring of the fastening device of FIG. 3;

FIG. 4B is an end view of the spring of FIG. 4A; and

FIG. 5 is a perspective view of the cable end connection assembly of the present invention with a connector and a portion of a casing removed for simplicity.

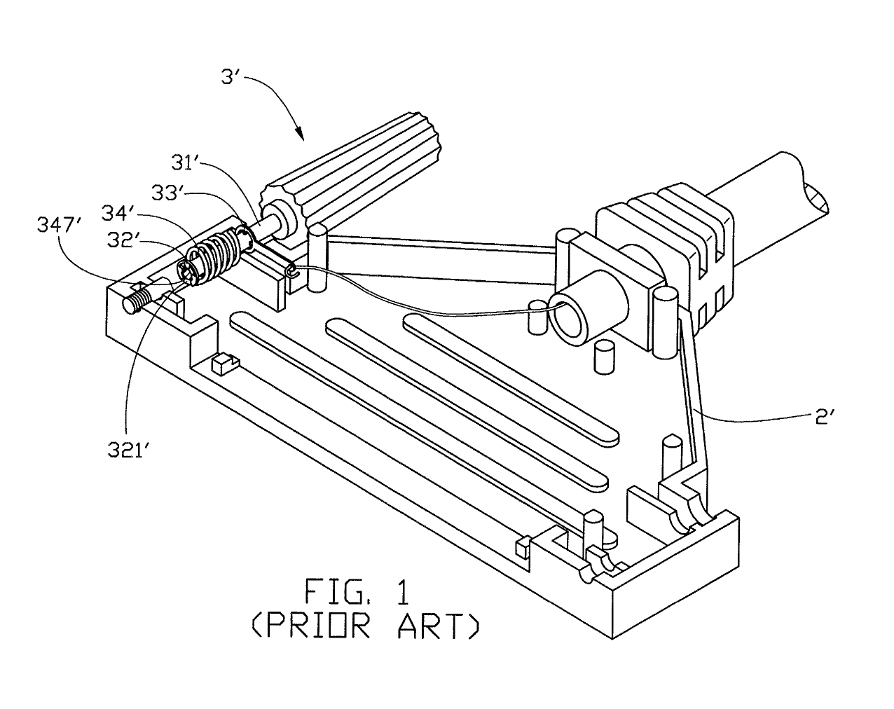

### DETAILED DESCRIPTION OF THE PREFERRED EMBODIMENT

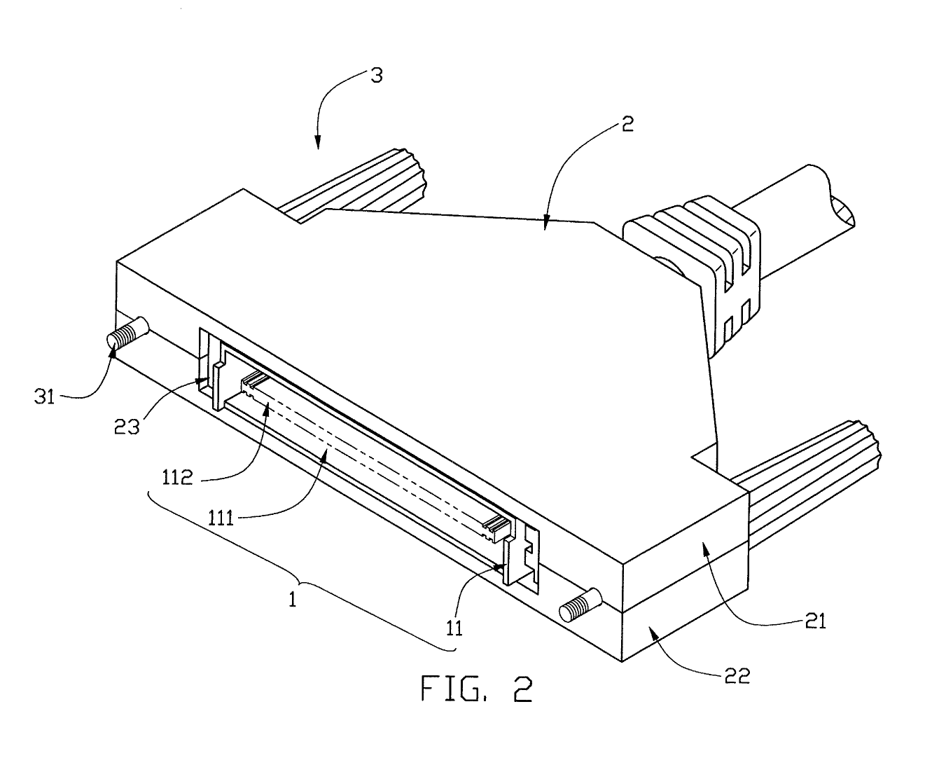

With reference to the drawings and in particular to FIG. 2, a cable end connection assembly constructed in accordance with the present invention comprises an outer casing 2 generally consisting of upper and lower halves 21, 22 mating each other and defining an interior space (not labeled) therebetween for receiving and a retaining an electrical connector 1. An opening 23 is defined in a front face of the outer casing 2 for exposing the connector 1 and receiving a mating connector (not shown) to form electrical connection between the cable end connection assembly and the mating connector.

The connector 1 comprises an insulative housing 11 defining a receiving slot 111 which is exposed through the front opening 23 of the outer casing 2 for receiving the mating connector. A central board 112 is formed in the receiving slot 111 for supporting a number of conductive contacts (not labeled) thereon. The conductive contacts are engageable with corresponding contacts of the mating connector when the mating connector is plugged into the receiving slot 111 of the connector 1.

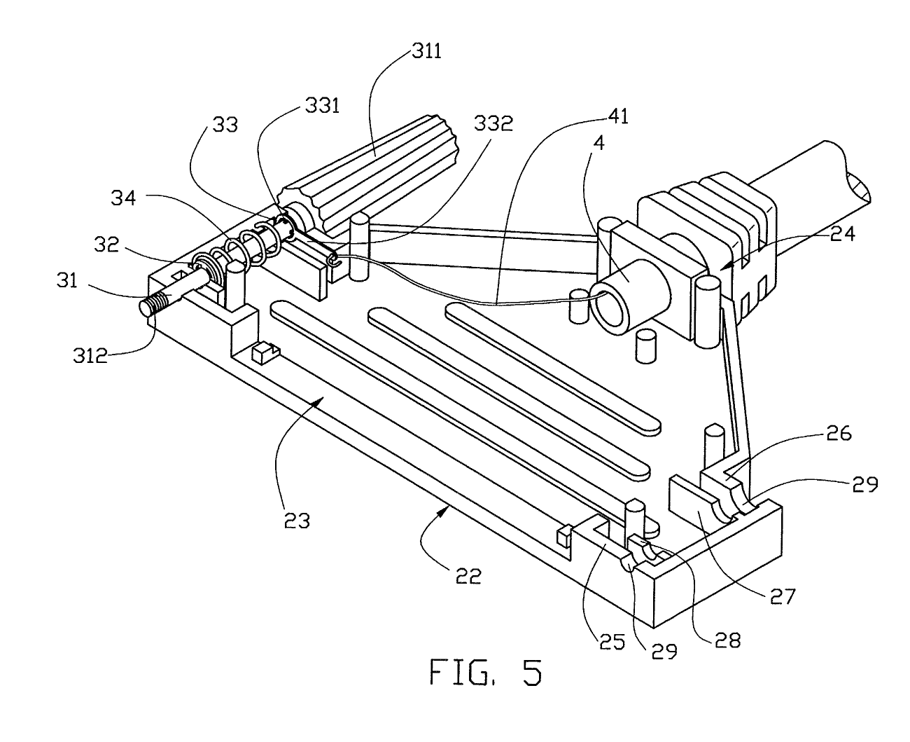

Also referring to FIG. 5, a passage 24 is defined in a rear wall (not labeled) of the casing 2 through which an end of a cable 4 extends. The end of the cable 4 is connected to the conductive contacts of the connector 1 whereby the cable 4 is electrically connected to the mating connector via the engagement between the contacts of the connector 1 and those of the mating connector.

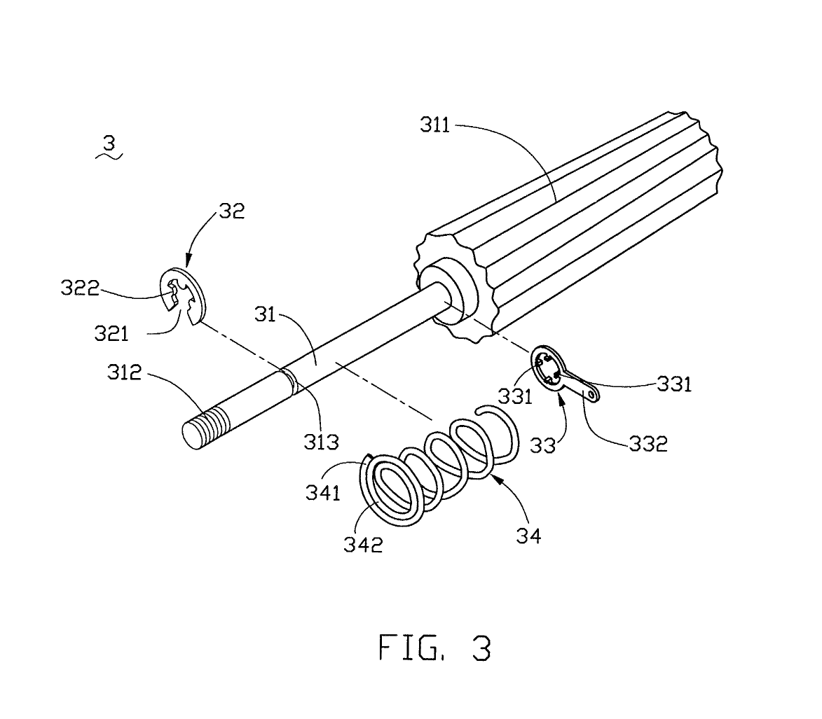

The cable end connection assembly further comprises a pair of fastening devices 3 arranged on opposite sides of the connector 1. As shown in FIGS. 3 and 5, each fastening device 3 comprises an elongate rod 31 rotatably and axially movably supported in the casing 2. Two aligned holes 29 are defined in opposite outer walls 25, 26 of the casing 2 for rotatably supporting the rod 31. Preferably, the walls 25, 26 are substantially parallel to each other.

Further, two inner walls 27, 28 are formed inside the casing 2 between the outer walls 25, 26 and are preferably parallel to each other and the outer walls 25, 26. Holes that are aligned with holes 29 of the outer walls 25, 26 are defined in the inner walls 27, 28 for supporting the rod 31.

The rod 31 has opposite ends respectively extending beyond the outer walls 25, 26. A manual knob 311 is formed on one of the ends and threading 312 is formed on the other end. A grounding ring 33 is fit over the rod 31 and forms a plurality of inwardly extending tabs 331 for physical engagement with the rod 31. The grounding ring 33 also forms an outward extending lug 332 for connection with a grounding wire 41 of the cable 4.

A circumferential groove 313 is defined in the rod 31 for retaining a C-ring 32. The C-ring 32 forms a side opening 321 for mounting the C-ring 32 onto the rod 31 and a plurality of inward projections 322 received in the groove 313 for retaining the C-ring 32 on the rod 31 in such a way that a ring portion of the C-ring 32 surrounds the rod 31 and extends beyond the groove, forming a circumferential rib around the rod 31, except the side opening 321.

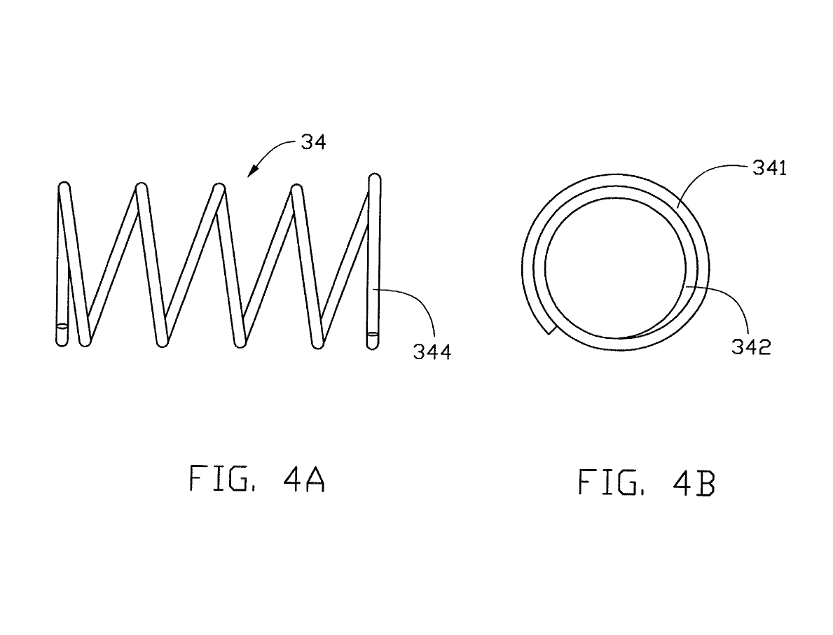

Also referring to FIGS. 4A and 4B, a helical spring 34 comprising a number of regular turns 342 is retained between the C-ring 32 and one of the inner walls 27, 28 for biasing the rod 31 in a desired direction. In the embodiment illustrated, the helical spring 34 is arranged between the C-ring 32 and the inner wall 27.

To prevent a free end of the wire that makes the helical spring 34 from accidentally getting into the side opening 321 of the C-ring 32 and thus causing the spring 34 to lose abutting engagement with the C-ring 34, an end of the helical spring 34 that abuts against the C-ring 34 is formed with an additional turn 341 having an inside diameter substantially corresponding to an outside diameter of the regular turns 342 of the spring 34. The additional turn 341 is in close engagement with and surrounds a last one of the regular turns 342 whereby an expanded and continuous end turn 344 of the helical spring 34 is formed which eliminates the free end of the conventional helical spring.

Apparently a helical spring having a continuous end turn can be formed in a variety of other ways for effectively preventing the free end of the spring from getting into the side opening of the C-ring.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A cable end connection assembly comprising:
an outer casing;
an electrical connector received and retained in the outer casing; and
at least one fastening device mounted in the outer casing, the fastening device comprising a rod rotatably and axially movably supported in the outer casing, and a helical spring biasing the rod in a predetermined direction, wherein the helical spring has an end forming a continuous turn.

2. The cable end connection assembly as claimed in claim 1, wherein the helical spring comprises a number of regular turns having an outside diameter and an additional turn having an inside diameter substantially corresponding to the outside diameter of the regular turns, the additional turn surrounding and in close engagement with a last one of the regular turns in said end of the helical spring.

3. The cable end connection assembly as claimed in claim 1, wherein a C-ring having a side opening is mounted on the rod, said end of the helical spring abutting against the C-ring.

4. The cable end connection assembly as claimed in claim 3, wherein the helical spring has an opposite end abutting against a wall of the outer casing for biasing the rod.

5. A cable connector assembly comprising:
an outer casing;
an electrical connector retained in the outer casing;
one fastening device positioned beside said connector, said fastening device including a rod rotatably and axially movable in the outer casing;
a C-ring mounted to said rod with an opening radially communicative with an exterior; and
a helical spring surrounding said rod and defining an end with thereof more than one turns to abut against the C-ring for preventing the distal end tip thereof from mistakenly entering the opening.

6. The assembly as claimed in claim 5, wherein said more than one turns extend in a plane perpendicular to an axial of said helical spring.

7. The assembly as claimed in claim 6, wherein said more than one turns result in an outer diameter larger than that of the C-ring.
